(19) United States
(12) Patent Application Publication
(10) Pub. No.: US 2003/0064189 A1
(43) Pub. Date: Apr. 3, 2003

(54) Disposable cover for protecting eating ware

(76) Inventors: Larry Berg, San Marcos, CA (US); Susie Berg, San Marcos, CA (US)

Correspondence Address: MURPHEY & MURPHEY, A.P.C., 701 PALOMAR AIRPORT DRIVE, SUITE 260, CARLSBAD, CA, 92009, US

(21) Appl. No.: 09/970,483

(22) Filed: Oct. 3, 2001

(51) Int. Cl. B32B 7/06

(52) U.S. Cl. 428/40.1; 428/201; 428/195

(57) ABSTRACT

A disposable cover for protecting eating utensils from contact with contaminants located on an eating surface, including, in combination, a thin sheet of material for positioning to one side of a place setting on an eating surface and of a finite size and shape to provide a complete barrier between the eating surface and a napkin and/or eating utensils deposited on the sheet, an adhesive incorporated in the thin sheet of material for preventing the sheet from slipping on the eating surface during repeated withdrawal and deposit of eating utensils on it, an antibacterial and antiviral agent impregnated into the sheet to act as a barrier between possible contaminants on the eating surface and the eating utensils, and a moisture barrier associated with the sheet to prevent moisture on the eating surface from passing therethrough to contact the eating utensils and the napkin deposited thereon, wherein the thin sheet of material is adaptable to be stored one-on-top-of-another in a pad to be easily carried by a waitperson and readily peeled therefrom in single sheets for placement on the eating surface.

### BACKGROUND OF THE INVENTION

1. Field of the Invention

This invention pertains to the food industry. More particularly, it pertains to a disposable cover for placement on an eating surface under the eating utensils to provide a germ-free barrier between the eating surface and the utensils to protect people from contaminants often found on germ-laden counters, tables and the like.

2. Description of the Prior Art

The cost of living, including the cost of buying real estate and raising children, has led to family organizations where both parents working at jobs outside the home. This has led to a general inability for one parent to prepare large meals at home for the family. The food industry has recognized this phenomenon and more and more restaurants, cafes and other eating establishments have been created to provide these hard-working parents and their children with a place to obtain a cooked meal without the concomitant task of preparing the food, setting and clearing the table and washing the dishes.

In many situations, there is an issue concerning the cleanliness of the surface upon which the eating utensils, i.e., the knife, fork, and spoon, are placed before and during the eating process. The table or other eating surface may not have been wiped clean from prior use or, if cleaned, is often wiped clean using a rag or towel that has been used to wipe up other eating surfaces at nearby tables or other locations. While this act of attempted cleanliness is commendable, the fact remains that food scraps, spilled liquids, and food handled by persons without clean hands, all possibly laden with harmful bacteria and viruses, may be transferred from one user to another.

Even more important is the fact that placement of eating utensils directly on the surface of the recently-wiped eating location insures that the blade of the knife, and the back of the fork and spoon, will directly contact the eating surface and bacteria or viruses found thereon may be transferred to the utensils and into the mouth of the consumer. Often, harmful microbes are transferred from the utensils directly into the mouth and onto the saliva-moistened gums and tongue. In addition, the casual carelessness of children, in cleaning eating surfaces in and out of the home can lead to the inescapable conclusion that the practice of ingesting food at locations outside the home raises a significant potential for severe contamination of eating utensils and can lead to the spread of diseases, especially bacterial and fungus infections such as hepatitis, staph and strep, salmonella, E. coli, Campylobacter, and athlete's foot, as well as viruses such as Rhinovirus (the leading cause of the common cold), Rotavirus (the leading cause of infectious diarrhea in children), Respiratory Syncytial Virus (the leading cause of lower respiratory infection in children), Poliovirus Type 1, Adenovirus Type 2, Herpes Simplex Virus Types 1 & 2, and Influenza A2 (Japan/305/57).

The prior art has attempted to prevent this situation by establishing “place” mats, made of paper and plastic, for placement directly under the dishes on which they are located during the eating process. See U.S. Pat. 4,326,006. Other prior art practices call for placement of large, multiple spots of adhesive, on the underside of large place covers, to prevent the cover from moving out from under the plate during use. See U.S. Pat. 5,712,012. These attempts have not proved satisfactory primarily because they are not directed at insulating the eating utensils from the eating surface but are used to prevent the plate, on which the food is served, from shifting or sliding on the eating surface. In addition, these prior art attempts concern large place covers that are stored in a tightly-wound roll to be carried about by the waitress or waiter and peeled therefrom for use. The roll is heavy and beyond the carrying capacity of many waitresses while the cover is large and will often tear when peeled from the roll.

As with all paper products, the cover can be printed with worthwhile messages concerning a wide variety of subjects from simple rules to enhance cleanliness at the eating location to advertisements for goods and services available in the local community.

### SUMMARY OF THE INVENTION

This invention is a disposable cover for protecting eating utensils from contact with contaminants located on eating surfaces in both the home and in restaurants, cafes, etc. The invention comprises a thin, flat sheet or cover of material of a size and shape at least slightly greater than the length and width of a setting of eating utensils for laying to one side of a place setting on an eating surface to accept over top thereof either a napkin and eating utensils or just eating utensils, means incorporated in the cover for preventing it from slipping on the eating surface during repeated withdrawal and deposit of eating utensils on top of it, an antibacterial agent impregnated into the cover of material to act as a barrier between possible contaminants on the eating surface and the eating utensils and a barrier, such as a sub-layer or coating of water impervious material, such as wax or plastic, to prevent germ-laden liquid from migrating upward from the unclean eating surface and onto the eating utensils. The thin sheet of material (cover) is adaptable to be stored in a pad, much like a tablet pad, and single layers thereof readily peeled therefrom for placement on the eating surface. The disposable cover is small in overall size, such as 40 square inches in area, and is thin and easily disposed. It does not incorporate layers of foam, layers of thick plastic and other such thickening materials. Accordingly, it is light weight and may be stored in pad form that is light weight and easily slipped into a pocket of an apron worn by waiters and waitresses. Further, its small size allows it to be readily peeled from the pad without tearing as happens with wider mats of the prior art. Still further, it is for placement only under the eating utensils and not under the dishwear and is not subject to sideways movement as often happens with dishes, cups and saucers. It uses a relatively small strip of adhesive on the bottom surface of each sheet, for holding the sheet in place on the eating surface and also for holding a plurality of sheets together in a single stack or pad. The cover may be made in large quantities using present-day calendaring equipment and printing presses so that it has a low cost per unit and may carry advertising or other information on its upper surface.

As with all such products, the invention is an inexpensive solution to a potentially serious problem and the few pennies put into the making of a pad of disposable covers or sheets can prevent a widespread attack of serious illness that can cost upwards of millions of dollars to effectively treat.

Accordingly, the main object of this invention is the prevention of the spread of bacterial and viral diseases. Other objects of the invention include a simple and effective means of insulating eating utensils from an eating surface without regard to the efforts of the food provider at cleaning the eating surface following prior uses; a low cost approach to preventing the spread of germs from one person to another that may be employed inside the home and in commercial eating establishments; an inexpensive and easy-to-use cover that may be stored on a light-weight pad and peeled off the pad in single layers and placed on the eating surface with ease; and, a cover that may be imprinted with a variety of useful information that is relevant to the eating establishment or in the community surrounding the eating facility.

These and other objects of the invention will become more clear when one reads the following specification, taken together with the drawings that are attached hereto. The scope of protection sought by the inventors may be gleaned from a fair reading of the claims that conclude this specification.

### BRIEF DESCRIPTION OF THE DRAWINGS

FIG. 1 is a top plan view of the cover of this invention in place on an eating surface under the eating utensils with accompanying place setting showing a corner of the cover turned upward to expose a portion of the underside thereof;

FIG. 2 is a perspective view of a plurality of single covers of this invention stacked in a pad, each sheet having printing located on the top surface thereof, showing how they are removed one-by-one from the pad, and showing the corners of the top three covers partially turned upward to expose a portion of the undersides thereof and the covers immediately above and below it;

FIG. 3 is a bottom plan view of a typical cover of this invention showing the location of printing on the upper surface and the preferred location of a glue line on the bottom surface thereof; and,

FIG. 4 is a close-up fragmentary view of a portion of a plurality of covers showing how they may be stacked in a group, pressed together to form a pad, and a line of glue applied along the aligned top or front edges of the stacked covers to hold them together in a pad for later peeling therefrom one-by-one, and the glue line reinforced with a plurality of threads.

### DESCRIPTION OF THE PREFERRED EMBODIMENT

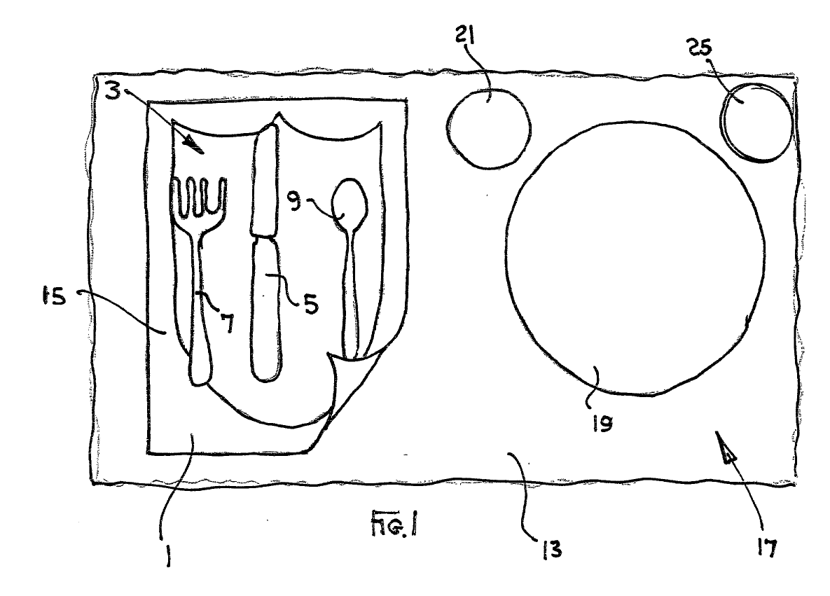

Turning now to the drawings, where each element is numbered and like elements are given like numbers through the four figures, FIG. 1 shows the preferred embodiment of the invention of a disposable cover 1, for protecting eating utensils 3, such as a knife 5, fork 7 and spoon 9 from contact with contaminants located on an eating surface 13. As further shown in FIG. 1, cover 1 is preferably in the form of a thin, flat sheet 15 of material of a size and shape, such as shown in FIG. 1, for laying to one side of a place setting 17, the place setting generally comprising a food plate 19, a bread plate 21 and glass of liquid 25, for location on eating surface 13. Cover 1 is surrounded by a front or top edge 27, a pair of opposed side edges, 29a and 29b, and a rear or bottom edge 31 all joined at their intersecting corners to form an enclosed perimeter 33. It is preferred that top or front edge 27 be made either in a straight line or a smooth curve and be devoid of scalloped edges so that, when cover 1 is peeled from a pad thereof, it peels easily from the pad and does not tend to tear at any location along front edge 27.

As shown in FIG. 2, a plurality of covers 1 may be assembled in a stack or pad 37 for ease in carrying about a plurality of them, and for later peeling one-by-one from the top of pad 37 for placement on an eating surface. The size and shape of pad 37, and covers 1, may be adjusted to have covers 1 large enough to cover all of the area under the eating utensils and the napkin, if the napkin is initially provided under the eating utensils, while at the same time, being small enough in area for the pad of them to fit in the pocket of a waitress' or waiter's smock. This is substantially different from the prior art practice of storing large place mats in a long, heavy roll that is often too large or heavy for expedient carrying about by the food server.

As further shown in FIG. 2, it is preferred that cover 1 include an upwardly facing top surface 39, spanning inside perimeter 33, and a downwardly facing bottom surface 41, also spanning inside perimeter 33. Each cover 1 in pad 37 is arranged where top surface 39 of one cover 1 is in full contact with bottom surface 41 of the cover immediately above it and the bottom surface 41 of cover 1 is in full contact with top surface 39 of the cover immediately below it. These covers may be made by a presently existing calendaring process such as used in making newspaper or other such sheet material.

Eating utensils 3 is the general term given to all utensils used to transfer food from an eating surface into the user's mouth. This term includes knives, forks, spoons and tongs as well as chop sticks and utensils of other cultures used in feeding oneself. The eating utensils may be made of metal, such as pewter or silver, or non-metal, such as plastic, ivory and bamboo.

Eating surface 13 is any surface wherein eating utensils 3 are deposited, whether along with a plate, serving tray, box, or other container of food. Eating surface 13 is preferably flat (planar) and level, such as found in restaurants, cafes and other eateries. However, any surface wherein eating utensils 3 may be deposited during use will qualify as eating surface 13. Place setting 9 is any plate, bowl or other container of food from which the user of cover 1 is eating and may comprise a single plate or bowl or a combination of them. This invention is not for use under a place setting mat primarily because there is little or no contact between the bottom of these dishes and one's mouth.

Cover 1 is preferably comprised of a thin sheet 43 of material that can be readily made in large quantities using existing manufacturing equipment, such as calenders and the like, so that the individual sheets are inexpensive. Each sheet 43 is to be cut to a size and shape as shown in the Figures to provide a complete barrier between eating surface 13 and a napkin and/or eating utensils 3 deposited on cover 1. A napkin is not shown in the drawings. If a napkin is placed under eating utensils 3, once the eating process begins, it is moved to the lap of the user and the eating utensils are left to be deposited (lift and set down) on cover 1.

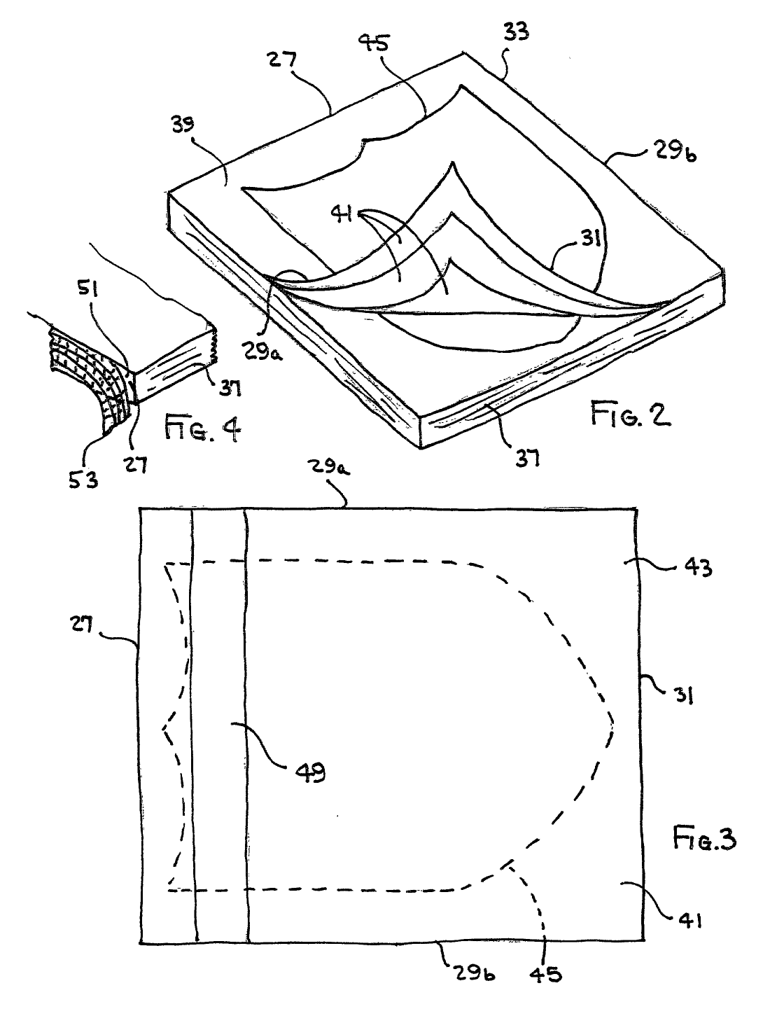

It is preferred that cover 1 be made of paper, such as a cellulose-based paper, or plastic and contain a barrier layer of wax, plastic or other water impervious material. It is preferred to have a calendared upper or top surface 39, preferably smooth in texture, a flat, preferably smooth lower or bottom surface 41 and be constructed in a thickness preferably from 2 to 5 mils. Upper surface 39 may contain additional features including printing 45, such as shown in FIGS. 1 and 2 and also shown in dotted outline in FIG. 3. Printing 45 may contain a wide variety of messages, such as advertising slogans and other interesting advertising phrases and designs.

As shown in FIG. 3, cover lower or bottom surface 41 preferably contains a means for preventing cover 1 from slipping on eating surface 13. As shown, the means includes a narrow strip 49 of a thin layer of an adhesive, preferably deposited by calendar roll or the like, that is weak enough to allow cover 1 to be easily and quickly peeled or removed from pad 37, as shown in FIG. 2, yet strong enough, when laid on eating surface 13, to withstand side pressures lodged against cover 1 during eating of food, that would, in the absence of such adhesive, cause sliding of cover 1 across eating surface 13 and out from under eating utensils 3. The adhesive should also be weak enough to allow cover 1 to be peeled from eating surface 13, when clearing the eating position for the next customer, without leaving any trace of adhesive 49 or sheet material 15 thereon. Such an adhesive is readily available in the market and easily carried in a water or other solvent solution for application to bottom surface 41 by a calendar roll or brush (not shown) on lower cover surface 41, air dried and then the single sheets or covers accumulated and stacked into pad 37. When the adhesive-coated (bottom surface 41 only) sheets are stacked into pad 37 and squeezed together, pad 37 becomes a homogeneous stack of separate pads held together by the adhesive strips as shown in FIG. 2.

While the preferred form of pad 37 is shown in FIG. 3, i.e., where narrow stripe of adhesive 49 is located slightly inward from top end 27 and parallel to it, so that each edge of cover 1 is free to be bent upward by the waitperson to peel one cover off pad 37, a modification is shown in FIG. 4 where a thin line 51 of glue or adhesive is applied along the aligned top or front edges 27 of a stack of covers 1 to hold them together in a pad for later peeling therefrom one-by-one. As further shown in FIG. 4, glue line 51 may be reinforced with a layer 53 of woven fibers that is pressed into adhesive stripe 51 to reinforce the pad structure.

As part of the manufacturing process of cover 1, it is preferred that an antibacterial and/or anti-viral agent be deposited on or soaked into cover 1 to combat the potential for germs from an unclean eating surface migrating upward, from bottom cover surface 41 to top cover surface 39 and onto the eating utensils deposited thereon. Antibacterial and anti-viral agents are available on the market and are available in a form, such as a water solution, that may be readily deposited onto cover 1 to soak therein and later be dried to provide for an inventory of such material to combat these diseases. Examples of such anti-bacterial agents and antivirus agents include Dimethyl Benzyl Ammonium Saccharinate, Zanamivir (Relenza), GS4104, Amantadine, and Rimantadine.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A disposable cover for protecting eating utensils from contact with contaminants located on an eating surface, comprising, in combination:
a) a thin, flat sheet of material for positioning to one side of a place setting on an eating surface and of a finite size and shape to provide a complete barrier between the eating surface and a napkin and/or eating utensils deposited on said sheet;
b) means incorporated in said thin sheet of material for preventing said sheet from slipping on the eating surface during repeated withdrawal and deposit of eating utensils on it;
c) an antibacterial and antiviral agent impregnated into said sheet to act as a barrier between possible contaminants on the eating surface and the eating utensils; and,
d) means associated with said sheet to prevent moisture on the eating surface from passing therethrough to contact the eating utensils and the napkin deposited thereon;
e) wherein said thin sheet of material is adaptable to be stored one-on-top-of-another in a pad to be easily carried by a waitperson and readily peeled therefrom in single sheets for placement on the eating surface.

2. The disposable cover for protecting eating utensils from contact with contaminants located on an eating surface, of claim 1 wherein said sheet of material is surrounded by a front or top edge, opposed side edges, and a rear or bottom edge, all joined at their intersecting corners to form an enclosed perimeter and wherein said front edge is formed in a straight edge or single curved line totally devoid of scalloped edges in order to easily and fully peel said cover from said pad of said covers.

3. The disposable cover for protecting eating utensils from contact with contaminants located on an eating surface, of claim 1 wherein said thin sheet of material is comprised of cellulose-based paper.

4. The disposable cover for protecting eating utensils from contact with contaminants located on an eating surface, of claim 1 wherein said thin sheet of material includes other materials selected from the group consisting of plastic, wax, and other impervious materials.

5. The disposable cover for protecting eating utensils from contact with contaminants located on an eating surface, of claim 1 wherein said cover includes an upwardly facing top surface and a downwardly facing bottom surface, said top surface adapted for contact with the eating utensils.

6. The disposable cover for protecting eating utensils from contact with contaminants located on an eating surface, of claim 1 wherein said bottom surface of said cover is adapted for placement on and contact with the eating surface.

7. The disposable cover for protecting eating utensils from contact with contaminants located on an eating surface, of claim 6 further including a narrow strip of a thin layer of weak adhesive applied to said bottom surface for contact with the eating surface to prevent said cover from slipping on the eating surface during use

8. The disposable cover for protecting eating utensils from contact with contaminants located on an eating surface, of claim 7 wherein said narrow strip of a thin layer of weak adhesive covers only a small portion of said bottom surface and said adhesive is of the type that is easily peeled from the eating surface leaving no trace thereon.

9. The disposable cover for protecting eating utensils from contact with contaminants located on an eating surface, of claim 5 further including printed material placed on said upwardly facing top surface thereof.

10. The disposable cover for protecting eating utensils from contact with contaminants located on an eating surface, of claim 5 wherein said antibacterial and antiviral agent, impregnated into said sheet of material, is selected from the group consisting of Dimethyl Benzyl Ammonium Saccharinate, Zanamivir (Relenza), GS 4104, amantadine, and rimantadine.

11. The disposable cover for protecting eating utensils from contact with contaminants located on an eating surface, of claim 8 wherein said pad of covers is maintained together by squeezing said strips of adhesive together into a cohesive stack.

12. The disposable cover for protecting eating utensils from contact with contaminants located on an eating surface, of claim 8 wherein said pad of covers is maintained together by being stacked together in a pad and temporarily attached to each other by a layer of adhesive deposited along each of said front edges of said covers and the covers thereafter squeezed together.

13. The disposable cover for protecting eating utensils from contact with contaminants located on an eating surface, of claim 12 wherein said layer of adhesive is reinforced with a layer of woven threads.

14. A disposable cover for protecting eating utensils from contact with contaminants located on an eating surface, comprising, in combination:
a) a thin, flat sheet of material for positioning to one side of a place setting on an eating surface and of a finite size and shape to provide a complete barrier between the eating surface and a napkin and/or eating utensils deposited on said sheet, said sheet of material surrounded by a front or top edge, opposed side edges, and a rear or bottom edge, all joined at their intersecting corners to form an enclosed perimeter and wherein said front edge is formed in a straight edge;
b) means incorporated in said thin sheet of material for preventing said sheet from slipping on the eating surface during repeated withdrawal and deposit of eating utensils on it;
c) an antibacterial and antiviral agent impregnated into said sheet to act as a barrier between possible contaminants on the eating surface and the eating utensils; and,
d) means associated with said sheet to prevent moisture on the eating surface from passing therethrough to contact the eating utensils and the napkin deposited thereon;
e) wherein said thin sheet of material is adaptable to be stored one-on-top-of-another in a pad to be easily carried by a waitperson and readily peeled therefrom in single sheets for placement on the eating surface.

15. The disposable cover for protecting eating utensils from contact with contaminants located on an eating surface, of claim 14 wherein said thin sheet of material is comprised of cellulose-based paper.

16. The disposable cover for protecting eating utensils from contact with contaminants located on an eating surface, of claim 14 wherein said thin sheet of material includes other materials selected from the group consisting of plastic, wax, and other impervious materials.

17. The disposable cover for protecting eating utensils from contact with contaminants located on an eating surface, of claim 14 wherein said cover includes an upwardly facing top surface and a downwardly facing bottom surface, said top surface adapted for contact with the eating utensils.

18. The disposable cover for protecting eating utensils from contact with contaminants located on an eating surface, of claim 14 wherein said bottom surface of said cover is adapted for placement on and contact with the eating surface.

19. The disposable cover for protecting eating utensils from contact with contaminants located on an eating surface, of claim 18 further including a narrow strip of a thin layer of weak adhesive applied to said bottom surface for contact with the eating surface to prevent said cover from slipping on the eating surface during use.

20. The disposable cover for protecting eating utensils from contact with contaminants located on an eating surface, of claim 19 wherein said narrow strip of a thin layer of weak adhesive covers only a small portion of said bottom surface and said adhesive is of the type that is easily peeled from the eating surface leaving no trace thereon.
